(19) United States
(12) Patent Application Publication
(10) Pub. No.: US 2014/0106332 A1
(43) Pub. Date: Apr. 17, 2014

(54) METHOD AND APPARATUS FOR MOBILE SOCIAL LEARNING

(71) Applicants: Richard Gessner, San Diego, CA (US); David Scott Wilson, San Jose, CA (US); Wesley Janse van Rensburg, San Diego, CA (US)

(72) Inventors: Richard Gessner, San Diego, CA (US); David Scott Wilson, San Jose, CA (US); Wesley Janse van Rensburg, San Diego, CA (US)

(21) Appl. No.: 13/843,073

(22) Filed: Mar. 15, 2013

Related U.S. Application Data
(60) Provisional application No. 61/713,406, filed on Oct. 12, 2012.

(51) Int. Cl. G09B 5/08

(52) U.S. Cl. CPC G09B 5/08
USPC 434/350

(57) ABSTRACT

A method and apparatus of a device that measures and responds to the level engagement of a student with a mobile social learning system is described. In an exemplary embodiment, the device monitors a stream of student events, where each student event characterizes an aspect of engagement the student has with the mobile social learning system. The device classifies the student event with a mobile social learning classification, where the classifying determines a student event class for the student event. The device further matches a student event-based trigger with the student event class, where the student event-based trigger includes an action to be performed if the student event-based trigger matches the student event. If the student event-based trigger matches the student event, the device performs the action.

### RELATED APPLICATIONS

Applicant claims the benefit of priority of prior, co-pending provisional application Ser. No. 61/713,406, filed Oct. 12, 2012, the entirety of which is incorporated by reference.

### FIELD OF INVENTION

This invention relates generally to education and more particularly to determining a student's engagement with a mobile social learning system.

### BACKGROUND OF THE INVENTION

An electronic learning system is a system that allows students to participate in an education using electronically learning and teaching. The student can participate in classes and discussions remotely using devices that communicate over a network. For example, educational content is delivered via the Internet, an internet/extranet, cellular and/or some other form of data network. The educational content can be self-paced and/or instructor-led, and the content can include media in the form of text, image, animation, video, and/or audio. By having the student remotely access the educational content, the student has flexibility as to when or where to access the educational content.

One problem with electronic learning is that because students are remote from an instructor much of the time, it is more difficult for the instructor or other staff to determine if the student is fully engaged with the electronic learning system. In a traditional learning system, a teacher can monitor a student's engagement with the class by determining the student's attendance, performance, and participation in the class. For example, a student's participation, or lack thereof, can be monitored by a teacher's in-class observation of the student's participation and performance. In contrast, where the student is involved in an electronic learning system and is remote from the instructor, it is difficult for the teacher to determine if the student is engaged with the electronic learning system.

### SUMMARY OF THE DESCRIPTION

A method and apparatus of a device that measures and responds to the level engagement of a student with a mobile social learning system is described. In an exemplary embodiment, the device monitors a stream of student events, where each student event characterizes an aspect of engagement the student has with the mobile social learning system. The device classifies the student event with a mobile social learning classification, where the classifying determines a student event class for the student event. The device further matches a student event-based trigger with the student event class, where the student event-based trigger includes an action to be performed if the student event-based trigger matches the student event. If the student event-based trigger matches the student event, the device performs the action.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is a block diagram of one embodiment of a mobile social learning system.

FIG. 2 is a block diagram of one embodiment of a plurality of different layer for a mobile social learning system architecture.

FIG. 3 is a flowchart of one embodiment of a process to perform automated engagement metrics.

FIG. 4 is a flowchart of one embodiment of a process to classify events.

FIG. 5 is a flowchart of one embodiment of a process to fire a trigger based on the classified events.

FIG. 6 is a system diagram of one embodiment of a data flow for automated engagement metrics.

FIG. 7 is a block diagram of one embodiment of an events processing module to perform automated engagement metrics.

FIG. 8 is a block diagram of one embodiment of a classifying events module to classify events.

FIG. 9 is a block diagram of one embodiment of an events processing module to fire a trigger based on the classified events.

FIG. 10 illustrates one example of a typical computer system, which may be used in conjunction with the embodiments described herein.

FIG. 11 shows an example of a data processing system, which may be used with one embodiment of the present invention.

### DETAILED DESCRIPTION

A method and apparatus of a device that measures and responds to the level engagement of a student with a mobile social learning system is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that measures and responds to the level engagement of a student with a mobile social learning system is described. In an exemplary embodiment, the device receives a stream of student events. Each student event can be an event that is captured from a student device that is used to interact with the mobile social learning system. The student event can be an action-based event (e.g., number of user events per day, number of postings to one or more discussion boards, number of participations number of student uploads to the mobile social learning system, etc.) or a time-oriented event (a time since last post in a discussion board, time since last login into the mobile social learning system, time since last activity in the mobile social learning system, etc.). The device further timestamps and saves the student event.

In order to determine whether a student is or is not fully engaged, a set of metrics is developed using previously collected student events. Analytics is performed on these collected student events to determine the set of metrics that measure a student's engagement with the mobile social learning system. These metrics are incorporated into a set to triggers that are used to match incoming student events to determine which student events indicate a possible lack of engagement.

In order to assist with the evaluating of incoming student events, each student event is classified using a mobile social learning classification. This classification classifies each incoming student event into a particular class, such an action-based class or a time-oriented class. Using the class, the device matches a trigger to the received student event. If the trigger matches, the device performs an action associated with the matching trigger. A matching trigger for the student event indicates that a student is becoming disengaged and has a possibility of abandoning the mobile social learning system. For example, the action can be sending an email to customer care, initiating a voice alert, etc.

### Mobile Social Learning

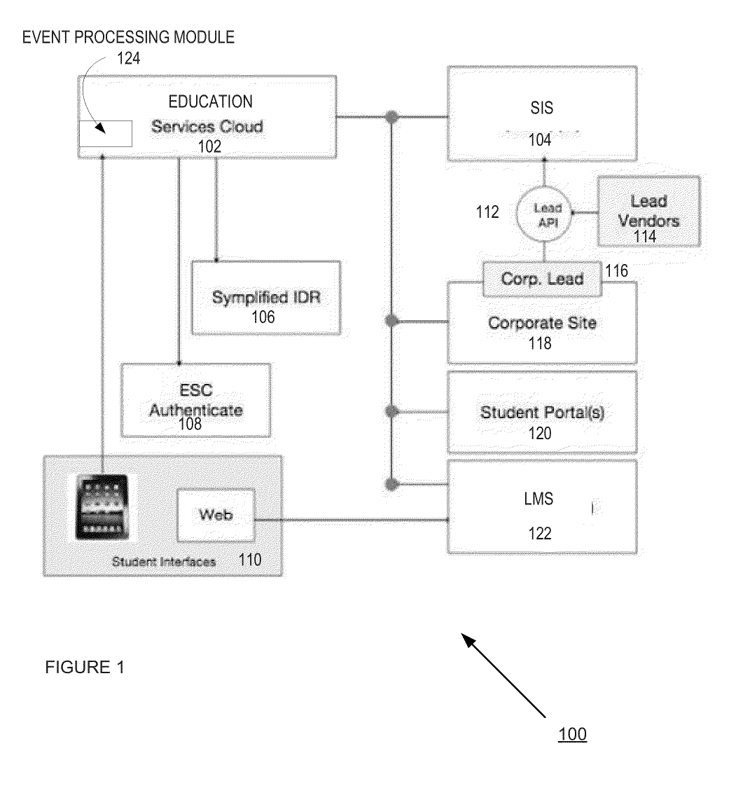

In one embodiment, the mobile social learning system is a system that enables electronic learning with an education service cloud via a student device. FIG. 1 is a block diagram of one embodiment of a mobile social learning system 100. In one embodiment, the mobile social learning system 100 includes an education services cloud (ESC) 102 that provides services to student interfaces 110. In addition, the ESC 102 is coupled to an identification and access manager (IAM) 106, ESC Authenticate 108, SIS 104, corporate site 118, student portal(s) 120, and learning management system (LMS) 122.

In one embodiment, the ESC 102 is a services cloud that ties together the different components of the mobile social learning system 100. In this embodiment, the components student interfaces 110, IAM 106, ESC Authenticate 108, SIS 104, corporate site 118, student portal(s) 120, and LMS 122 communicate with each other through the ESC 102. In one embodiment, the ESC 102 provides services to these different components such as a data store, automatic data synchronization between ESC 102 and the student mobile learning devices, data synchronization between SIS 104 and LMS 122, student curriculum construction that is specifically designed for that student, discovery and distribution of curriculum material for the student, student identity verification during remote test proctoring, message logging and routing, notifications and alerts, profile tracking, community presence indication, information caching, customer service interfaces, collecting and storing test answers, grades and/or attendance tracking.

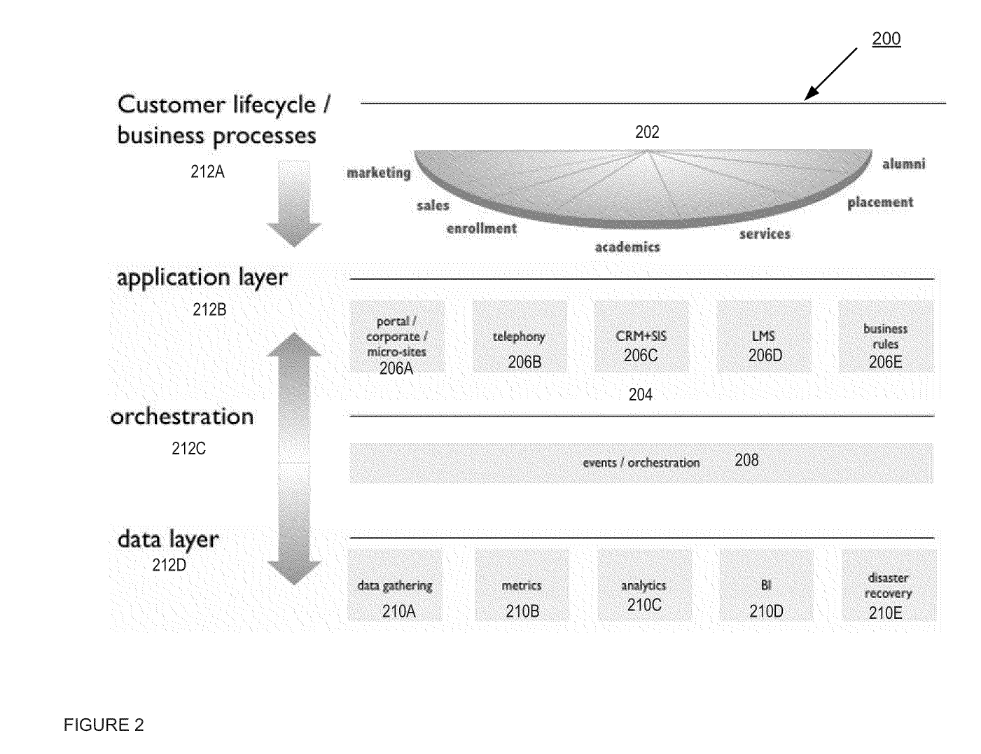

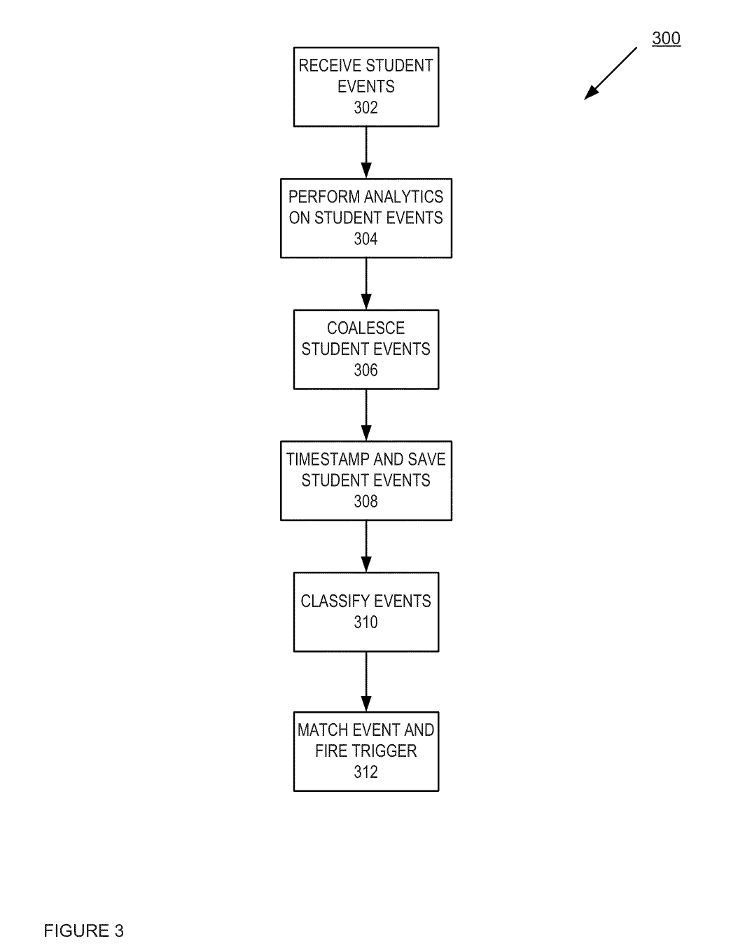

In one embodiment, ESC 102 includes an events processing module 124 that processes student events and uses these events for automated engagement metrics. In one embodiment, the ESC 102 uses automated engagement measures to determine a set of metrics that indicate whether a student is engaged in the mobile social learning system and is further used to identify those students that may not be engaged with the mobile social learning system. In one embodiment, those students not engaged in the mobile social learning system may be in danger of quitting the mobile social learning system or not fully participate in it, such that the student does not maximize their mobile social learning experience. If a student is determined not to be fully engaged, the ESC 102 may fire a trigger to alert the student, teacher, staff representative, etc. in order to take corrective action and have the student become more fully engaged with the mobile social learning system. The ESC 102 is described further below in FIG. 2. Automated engagement metrics is further described in FIGS. 3-5.

In one embodiment, the student interfaces 110 are the mechanism in which a student accesses the services in the ESC 102. In one embodiment, the student interfaces 110 are a native interface running on a mobile device (e.g., a tablet, smartphone, laptop, game console, etc.). For example and in one embodiment, the student interface 110 is running on a student mobile learning device. In another embodiment, the student interface 110 is a web interface running on a machine that is capable of accessing the World Wide Web. In one embodiment, the student interface 110 enables the student to access the services of the ESC 102, such as participate in online classes, view learning material, communicate with teacher/staff/other students, access and participate in discussion boards, take tests, access and manage administrative information, access and manage student profile, etc.

In one embodiment, the IAM 106 is component that manages the identification and access by a student to the ESC 102. For example and in one embodiment, students can use these same credentials to web applications or mobile applications. In one embodiment, the ESC Authenticate 108 handles the authentication of the students with the ESC 102. For example and in one embodiment, the ESC uses privately cached credentials to access student information in other system components such as the Learning Management System. In one embodiment, the student interface 110 communicates with the IAM 106 and ESC Authenticate 108 via the ESC 102 to acquire the identity credentials and use these credentials to authenticate with the ESC 102.

In one embodiment, SIS 104 stores the student information. In one embodiment, this student information includes contact information, the different curricula of the student (e.g., past, present and future curricula), captured gestures, student records, etc. In one embodiment, access to this student information is through the ESC 102 or a Lead API 112. In one embodiment, the SIS 104 stores leads, in which a lead is a person that has expressed interest in the mobile social learning system. In one embodiment, personnel administering the mobile social learning system can follow up this lead.

In one embodiment, corporate site 118 is a web site that provides information about the organization. In one embodiment, the corporate site is used to inform about the mobile social learning system and to generate leads for future students. In one embodiment, the corporate site 118 stores the generated leads through the lead API 112.

In one embodiment, student portal(s) 120 is a user interface for the student to access administrative functions of the mobile social learning system. In one embodiment, this student portal(s) 120 can be website user interface, purpose built user interface installed on the student interfaces 110, etc.

In one embodiment, LMS 122 is a system that allows the student to participate in one or more online classes. For example and in one embodiment, the LMS 122 is used for the administration, documentation, tracking, reporting, and delivery of education courses.

FIG. 2 is a diagram of one embodiment of a plurality of different layers of an ESC 200. In one embodiment, the ESC 200 serves as the technical foundation to orchestrate the overall online education solution. In one embodiment, the ESC 200 is designed to support a customer lifecycle model, where the customer lifecycle describes the process a customer goes through on their journey from “prospect” to “student” and beyond.

In one embodiment, the ESC 200 includes a customer lifecycle/business processes 212A, an application layer 212B, an orchestration layer 212C, and a data layer 212D. In one embodiment, the data layer 212D includes data gathering 210A, metrics 210B, analytics 210C, business intelligence 210D, and disaster recovery 210E. In one embodiment, the data gathering 210A gathers the event data that represent user actions and behaviors for future analysis. In one embodiment, the metrics 210B are the metric used to measure student performance, student engagement, system performance, student satisfaction, student-related issues, student availability, student participation levels, etc. In one embodiment, the analytics 210C includes descriptive and predictive models to gain valuable knowledge from data available to ESC 200. In addition, the analytics 210C may further include a comparison of metrics over time in order to detect and derive new user traits. In one embodiment, the metrics are aggregates of the student events and the analytics 210C are aggregates of metrics set to find higher-order patterns. In one embodiment, the business intelligence 210D includes a presentation capability to reveal and explore patterns and insights assembled by the analytics module (210C). In one embodiment, the disaster recovery 210E includes data that is used to reconstruct the ESC 200 in case of a disaster. In one embodiment, the orchestration layer 212C is provides messaging services, routing, caching, automation, and data storage.

In one embodiment, the application layer 212B is the layer that includes the applications 204 that are used to support the customer lifecycle/business process layer 212A. In one embodiment, the application layer 204 includes a portal/corporate/micro-sites 206A, telephony 206B, CRM+SS 206C, LMS 206D, and business rules 206E. In one embodiment, the portal/corporate/micro-sites 206A are the set of applications that support the student portal, corporate functions, and micro websites. The telephony 206B is a set of applications to support the telephony functions of the ESC 200 (e.g., sending alerts for engagement notification, etc.). The CRM+SS 206C is a set of applications to support the customer relation management and student services of the ESC 200. The LMS 206D is a set of applications that are used to support a student taking one or more online classes. The business rules 206E enable business processes to be automated and enforced across systems using system specific service-based interfaces.

In one embodiment, the customer lifecycle/business process layer 212A is the layer that represents the different business processes that occur during lifecycle of a customer as the customer progresses through prospect to student to alumni. In one embodiment, the different business processes are marketing, sales, enrollment, academics, services, placement, and alumni processes. These processes breakdown into pre-enrollment processes (marketing and sales), student processes (enrollment, academics, services, and placement), and post student process (alumni).

### Automated Engagement Metrics

In one embodiment, beyond rubric-based learning outcomes, a student may also participate in a set of non-test behaviors. These behaviors may include lectures, discussions, private conversations, researching topics and/or attendance in classroom learning activities. In one embodiment, defining and tracking non-test behaviors provides a way to gain an indicator of student retention. In one embodiment, this aggregated set of non-test behaviors can be an “engagement metric.”

In one embodiment, the engagement metric relies upon the automated tracking of primary virtual gestures initiated by the student in their online experience. The gestures are identified, captured, time-stamped and cached on a per-user basis. Using automated means, the resulting set of data is analyzed for time oriented predicative patterns that indicate a likelihood that the student will abandon their chosen program. Over a given threshold, the trend my trigger notifications to the customer care team, who may proactively contact the student in an attempt to resolve whatever challenges are leading the student to disengage.

FIG. 3 is a flowchart of one embodiment of a process 300 to perform automated engagement metrics. In one embodiment, the event processing module 124 of FIG. 1 above performs process 300. In FIG. 3, process 300 begins by receiving the student events at block 302. In one embodiment, the student events are the primary virtual gestures initiated by the student in their online experience as described above. In this embodiment, the ESC initiates the capturing the student events from the student devices (e.g., tablet, web site, etc.) as described above in FIG. 1. For example and in one embodiment, a primary virtual gesture is a login into the mobile social learning system, participation in an online class, participation in a discussion forum, contact with a staff and/or instructor (e.g., email, video chat, phone call, etc.). In another embodiment, the student event is a passage of time since a student has performed a gesture. In this embodiment, the ESC tracks the time since one of the primary virtual gestures listed above. This passage of time for a primary virtual gesture is presorted as a student event. For example and in one embodiment, the ESC tracks the passage of time since the student logged into the mobile social learning system, participated in an online class, participated in a discussion forum, and/or contacted with an instructor and/or other staff. In another embodiment, the student event can be a pattern of events, such as a student exhibiting participation in online classes only in close proximity to tests or assignment due dates, and/or timing of student behaviors in terms of effective habits that predict overall success.

At block 304, process 300 performs analytics on the received student events. In one embodiment, process 400 performs these analytics to derive and/or refine metrics that are used to determine if a student event indicates that a student is not engaged with the mobile social learning system. In one embodiment, these metrics are incorporated into triggers that are used to drive engagement behaviors by instructors and other staff that can enhance the learning outcomes and experience of the student. Such engagement behaviors include the automatic schedule of phone calls, or the sending of motivational or corrective email messages.

Process 300 performs coalesces the student events at block 306. In one embodiment, a coalescing process filters, rewrites and normalizes event flows into forms that can be recognized by classification systems. At block 308, process 300 timestamps and saves the student events. In one embodiment, process 300 timestamps and stores the events in the ESC, such as ESC 100 described in FIG. 1 above.

Process 300 classifies the student events in block 310. In one embodiment, the classifying of the events is to determine a student event class for each of the received student events. In one embodiment, the student event class can be an action-based event or a time-oriented event. For example and in one embodiment, an action based events are events that are based on an action, such as number of user events per day, number of postings to one or more discussion boards, number of participations number of student uploads to the mobile social learning system, updates to personal settings, uploading of course work, conversations with other students, reading course materials, engagement with counselors, etc. In one embodiment, the time-oriented event is a type of event that depends on a passage of time since a student event. For example and in one embodiment, a time-oriented event is a time since last post in a discussion board, time since last login into the mobile social learning system, time since last activity in the mobile social learning system, etc. Classifying a student event is further described in FIG. 3 below.

At block 312, process 300 matches the student events to a trigger and determines if the student event causes the matched trigger to fire. In one embodiment, process 300 matches a trigger to a student events based on the class of student that was determined at block 310 above. For example and in one embodiment, process 300 matches a time-oriented trigger to a time-oriented student event, an action-based trigger to a time-oriented student events, etc. In one embodiment, a time-oriented trigger is a trigger that is used to evaluate whether a time-oriented student event indicates that a student has disengaged, or is likely to disengage, from the mobile social learning system based on the time passage since a particular action has occurred. In another embodiment, an action-based trigger is a trigger that is used to evaluate whether an action-based student event indicates has disengaged, or is likely to disengage, based on an action taken by the student.

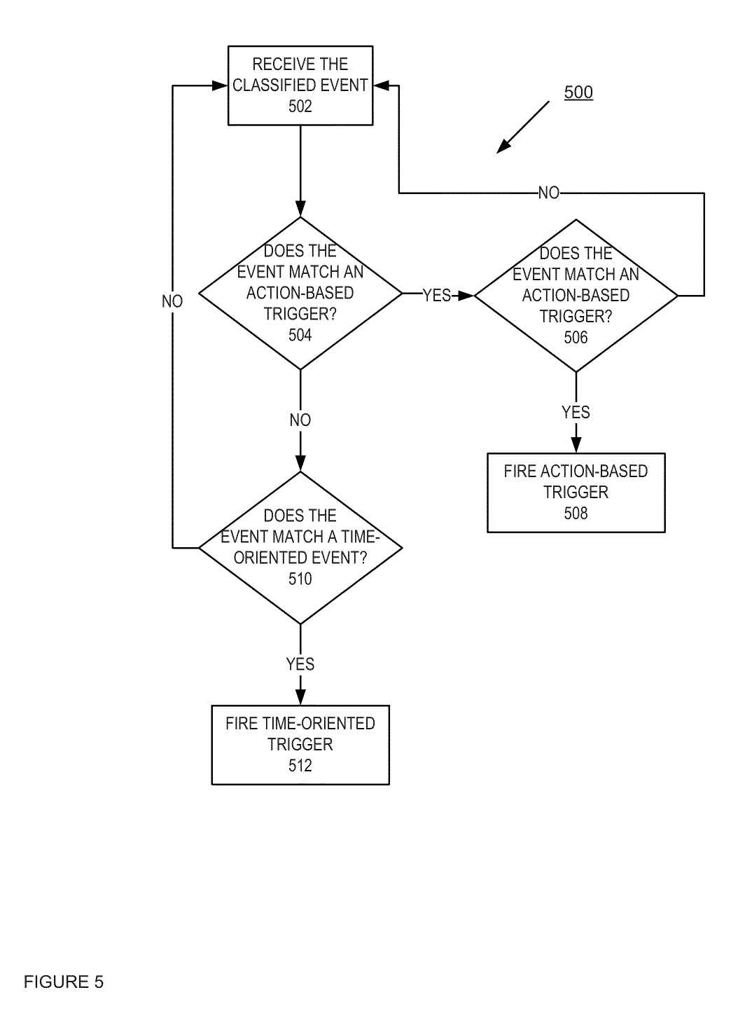

In one embodiment, by matching the trigger to the student event, process 300 fires the matched trigger. In one embodiment, the fired trigger initiates an action that is used to notify the staff that a student corresponding to the student event is likely to disengage from the mobile social learning system. In one embodiment, the firing of the trigger notifies a staff by email, voice alert, SMS messages, application notifications, creation of tasks in a workflow, auto-generation of customer cases, logging of problems for human review, etc. Matching and firing the triggers is further described in FIG. 5 below.

In one embodiment, process 300 is used to detect student events that indicate a likelihood that a student may abandon their engagement with the mobile social learning system. For example and in one embodiment, a student that logs in only once/day or posts only once/day may show that such a perfunctory behavior indicates this student has a likelihood of being poorly engaged with the mobile social learning system. In another embodiment, volume and timeliness measures in class discussions can reveal a lack of student attention or interest. When such an event is detected by the ESC, the ESC fire a triggers for this student and the customer care operation of the mobile social learning system is alerted that a student is poorly engaged.

As another example and embodiment, the ESC may derive a metric that a student who posts to discussion boards only in close proximity to a test date or other assignment due date is likely to not be engaged and may abandon their educational pursuits. In this example, if the ESC detects this pattern of behavior for a student, an alert is raised to the customer care operation that this student has a likelihood of not being engaged with the mobile social learning system and may abandon the program.

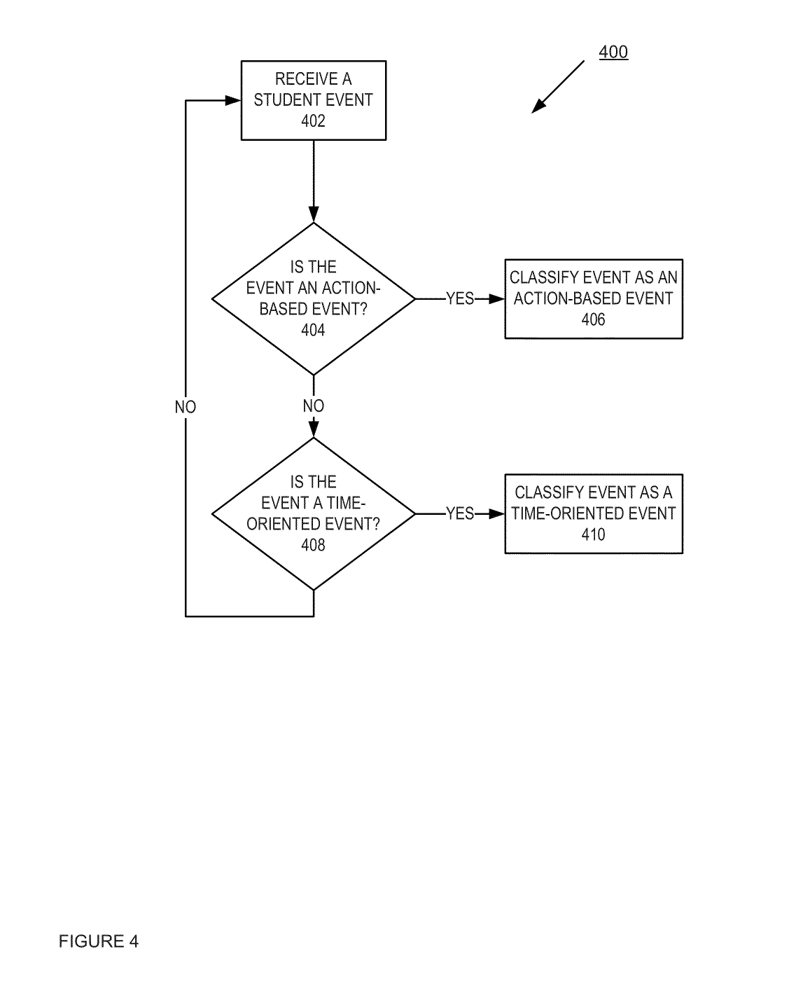

As described above, process 300 classifies the student events. This classification is used to match a student event to a trigger. FIG. 4 is a flowchart of one embodiment of a process 400 to classify events. In one embodiment, process 300 performs process 400 to process the events at block 310 in FIG. 3 above. In FIG. 4, process 400 begins by receiving the event to be classified at block 402. In one embodiment, the event is a student event that is captured by the ESC, such ESC 100 of FIG. 1 above.

At block 404, process 400 determines if the event is an action-based event. In one embodiment, an action-based event is an event that is based on an action, such as number of user events per day, number of postings to one or more discussion boards, number of participations number of student uploads to the mobile social learning system, etc. In one embodiment, a time-oriented event is an event that relates to the proximity of a user event to a pre-determined clock time, or to the latency between two identifiable user events within a pre-determined time-window, or actualized interval of a repeating sequence of identifiable user events. If the event is an action-based event, at block 406, process 400 marks this event as an action-based event. If the event is not an action based, execution proceeds to block 408 below.

Process 400 determines if the event is a time-oriented event at block 408. In one embodiment, a time-oriented event is a type of event that depends on a passage of time since a student event, such as a time since last post in a discussion board, time since last login into the mobile social learning system, time since last activity in the mobile social learning system, etc. In one embodiment, time-oriented events are identified by the proximity of an expected user event to a pre-defined event (such as uploading a file). In one embodiment, time-oriented events are identified by recognizable changes in the occurrence of user event patterns that relate to time, latency or the nature of events in a sliding window of time. If the event is a time-oriented event, at block 410, process 400 marks this event as a time-oriented event. If the event is not a time-oriented event, execution proceeds to block 402 above.

As described above, process 300 matches a trigger to a classified event and fire that trigger for a matched event. FIG. 5 is a flowchart of one embodiment of a process 500 to match and fire a trigger based on the classified events. In one embodiment, process 300 performs process 500 to match and fire a trigger for a classified student event at block 312, in FIG. 3 above. In FIG. 5, process 500 begins by receiving the classified event at block 502. In one embodiment, the received classified event is an event classified by process 400 as described in FIG. 4 above. At block 504, process 500 determines if the classified event is an action-based event. In one embodiment, process 500 queries the event to determine if the event is marked as an action-based event, a time-oriented event, or some other event. If the event is an action-based event, execution proceeds to block 506 below. If the event is a time-oriented event, execution proceeds to block 510 below.

At block 506, process 500 determines if the event matches an action-based trigger. In one embodiment, process 500 determines the match based on the class of the event. For example and in one embodiment, if the event is a number of user events per day, a matching trigger could be if the number of number of postings to one or more discussion boards is below a certain threshold number of postings (e.g., less than two posts per day, etc.). As another example and in another embodiment, if the event is a number of participations in an online class over a time period, a corresponding trigger is if the number of participations in an online class fall below a certain threshold (e.g. if the number of participation is below a certain percentage of total available participations, misses a percentage of participations over a week or month, misses one participation, etc.). As a further example and embodiment, if the event is number of student uploads to the mobile social learning system, a corresponding trigger could be if the number of student uploads falls below a certain threshold (e.g., student misses one or more key uploads, a percentage of uploads is below a threshold, total number of uploads is below a threshold, etc.). If the event does not match an action-based trigger, execution proceeds to block 502 above.

If the event does match an action-based trigger, process 500 fires the matching trigger at block 508. In one embodiment, each trigger has one or more associated actions that are initiated if that trigger is fired. In one embodiment, the associated action can be sending an email to a staff or instructor indicating that the student associated with the event has fallen below the metric indicated by the trigger. In another embodiment, the associated action can be a voice alert to a designated staff or instructor (e.g., automated phone call, etc.). In another embodiment, additional curriculum can be scheduled for delivery to the student electronic device. In another embodiment, a real-time video chat can be initiated between the student and relevant internal staff members. In another embodiment, the student can be virtually introduced other participants in the online learn environment (e.g. students or instructors).

If the event is a time-oriented event, at block 510, process 300 determines if the event matches a time-oriented trigger. In one embodiment, process 500 determines the match based on the class of the event. For example and in one embodiment, if the event is a passage of time since last post in a discussion board, a corresponding trigger could be if the student has not posted in a particular one of the discussion boards or any discussion boards after a certain time passage (e.g., hours, days, etc.). In another example and embodiment, if the event is a passage of time since last login into the mobile social learning system, a corresponding trigger could be if the student has not logged into the mobile social learning system on a daily basis, for each online class, etc. As a further example and embodiment, if the event is a passage of time since last activity in the mobile social learning system, a matching trigger could be if the student has not had any activity in a certain time (e.g., hours, days, etc.).

If the event does match a time-oriented trigger, process 500 fires the matching trigger at block 512. In one embodiment, each trigger has an associated action that is initiated if that trigger is fired. In one embodiment, the associated action can be sending an email to a staff or instructor indicating that the student associated with the event has fallen below the metric indicated by the trigger. In another embodiment, the associated action can be a voice alert to a designated staff or instructor (e.g., automated phone call), or calendar reminders can be automatically constructed and sent to the student or relevant staff member. In another embodiment, the event monitoring system can be given additional rules directed at the given student that seek to identify specific future event behaviors.

While in one embodiment, the event is described as matching one event, in alternate embodiments, the event may match more than one trigger (e.g., match more than one action-based trigger, more than one time-oriented trigger, match a combination of action-based and time-oriented triggers, etc.). For example and in one embodiment, a lack of student login over a period of time may match the triggers for lack of any activity and a lack of student login. A single event can trigger any number of event and/or time-oriented triggers as have been considered and described by users of this system. Triggers themselves can cascade to fire additional triggers as necessary.

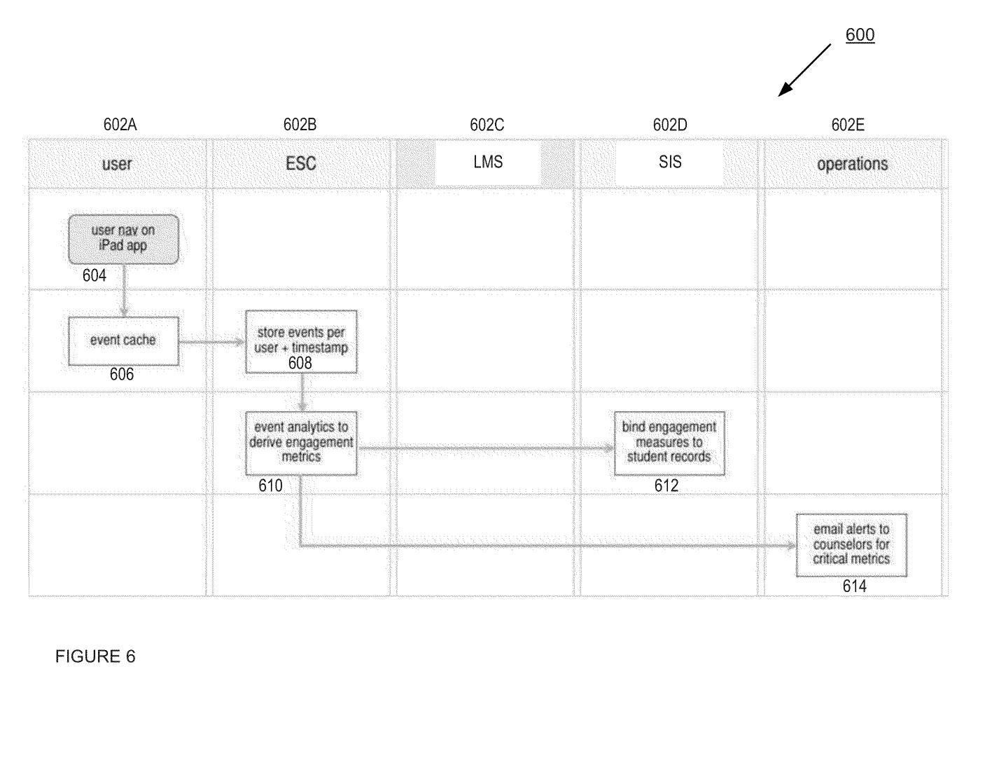

In FIGS. 3-5, student events are analyzed for metrics to determine an engagement measure and to process the events using the derived metrics. FIG. 6 is a system diagram of one embodiment of a data flow for automated engagement metrics. In FIG. 6, the data flow is through a system 600 that includes the student device 602A, ESC 602B, LMS 602C, SIS 602D, and operations 602E. In one embodiment, the student device 602A is a device the student uses to interact with the mobile social learning system, such as student interfaces 110 as described above in FIG. 1. In one embodiment, the ESC 602B is the services cloud that ties together the different components of the mobile social learning system, such as ESC 102 as described above in FIG. 1. In one embodiment, the LMS 602C a system that allows the student to take one or more online classes, such as LMS 122 as described above in FIG. 1. In one embodiment, the SIS 602D stores the student information, such as SIS 104 as described in FIG. 1 above. In one embodiment, operations 602E handles general student administration, such as customer support, payment support, IT support, instructor support, etc. In one embodiment, the operations processes are tracked in mission critical systems including the SIS 104, LMS 122, etc.

In one embodiment, the student events are captured in an event cache on the student device (e.g., a tablet, web site, etc.) (604, 606). In one embodiment, the student events are the primary virtual gestures initiated by the student in their online experience as described above. In one embodiment, the event cache is stored locally on the student device. In another embodiment, the student events are cached in an event cache in the ESC 602B. The ESC 602B receives the student events, timestamps the student events, and stores the student events per user (608). In one embodiment, the ESC 602B stores the student events on a per user basis. In one embodiment, the ESC timestamps and stores the student event as described above in FIG. 3, block 304.

In one embodiment, the ESC 602B performs event analytics to derive and/or refine engagement metrics (610). In one embodiment, these engagement metrics are incorporated into triggers. In one embodiment, the ESC 602B performs the analytics, derives the engagement metrics, matches events, and fires the triggers as described above in FIG. 1, block 104. In one embodiment, the SIS 602D binds the engagement metrics to the student records. In one embodiment, operations 602E emails alerts to the counselors for critical metrics. For example, if operations 602E opens a support ticket in the learning environment, the ESC automatically creates a case in the SIS and sends a message to the necessary support agent for immediate and timely response.

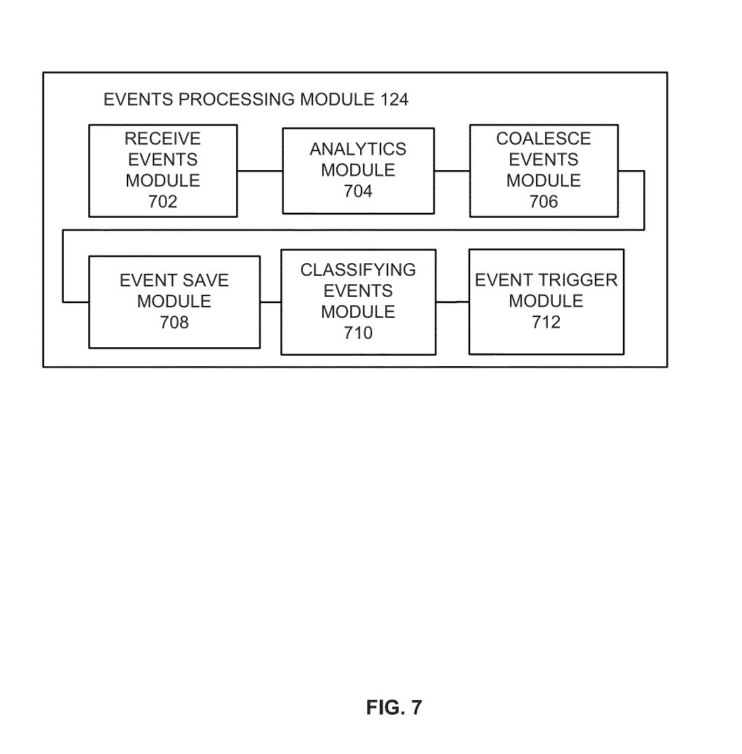

FIG. 7 is a block diagram of one embodiment of an events processing module 124 to perform automated engagement metrics. In one embodiment, the events processing module 124 includes receive events module 702, analytics module 704, coalesce events module 706, event save module 708, classifying events module 710, and event trigger module 712. In one embodiment, the receive events module 702 receives the student events as described above in FIG. 3, block 302 above. The analytics module 704 performs analytics on the student events and derives engagement metrics as described above in FIG. 3, block 304 above. The coalesce events module 706 coalesce the student events as described above in FIG. 3, block 306 above. The event save module 708 timestamps and saves the events as described above in FIG. 3, block 308 above. The classifying events module 710 classifies the student events as described above in FIG. 3, block 40 above. The event trigger module 712 matches a trigger to the classified events as described above in FIG. 3, block 302 above.

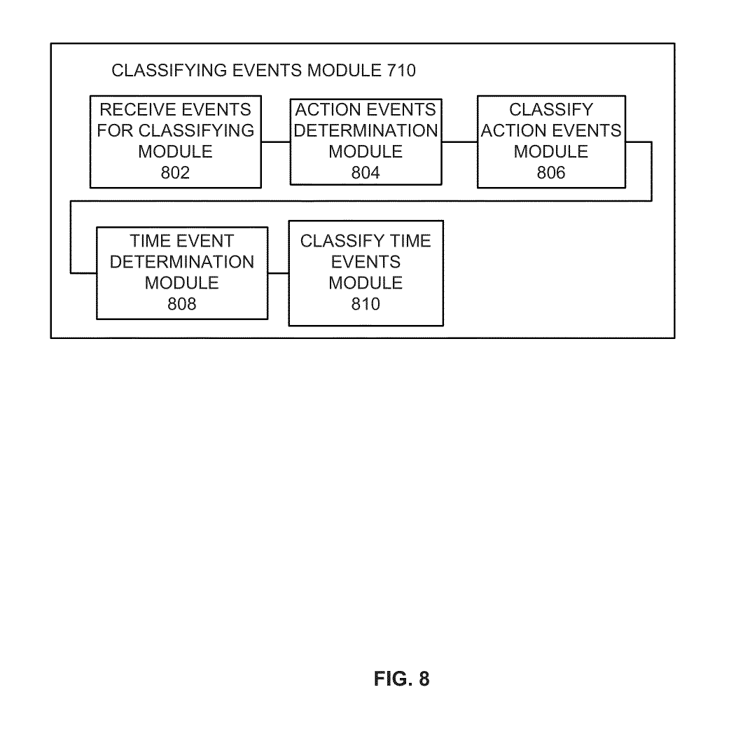

FIG. 8 is a block diagram of one embodiment of a classifying events module 710 to classify events. In one embodiment, the classifying events module includes a receive events for classifying module 802, action events determination module 804, classify action events module 806, time event determination module 808, and classify events module 810. The receive events for classifying module 802 receives the events as described above in FIG. 4, block 402. The action events determination module 804 determines if the event is an action-based event as described above in FIG. 4, block 404. The classify action events module 806 classifies the action events as described above in FIG. 4, block 406. The time event determination module 808 determines if the event is a time-oriented event as described above in FIG. 4, block 410. The classify time events module 810 classifies the time-oriented event as described above in FIG. 4, block 402.

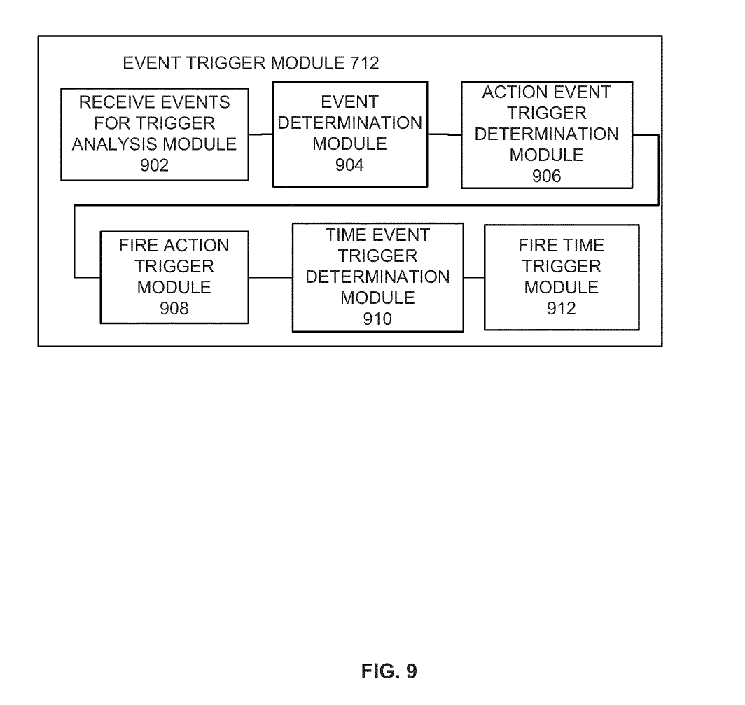

FIG. 9 is a block diagram of one embodiment of an events trigger module 712 to fire a trigger based on the classified events. In one embodiment, the events trigger module 712 includes receive events for trigger analysis module 902, event determination module 904, action event trigger determination module 906, fire action trigger module 908, time event trigger determination module 910, fire time trigger module 912. In one embodiment, the receive events for trigger analysis module 902 receive the events as described in FIG. 5, block 502 above. The event determination module 904 determines if the event is an action-based event or a time-oriented event as described in FIG. 5, block 504 above. The action event trigger determination module 906 matches the action-based event to a trigger as described in FIG. 5, block 506 above. The fire action trigger module 908 fires the action-based trigger as described in FIG. 5, block 508 above. The time event trigger determination module 910 matches the time-oriented event to a trigger as described in FIG. 5, block 510 above. The fire time trigger module 912 fires the time-oriented trigger as described in FIG. 5, block 512 above.

### Exemplary Systems

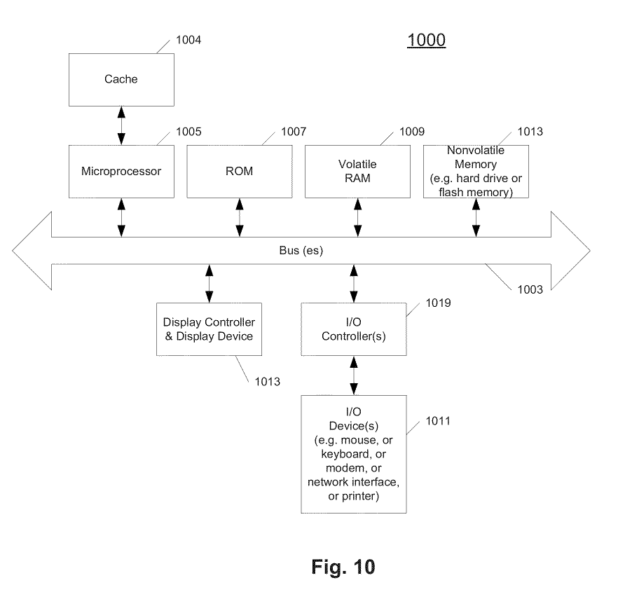

FIG. 10 shows one example of a data processing system 1000, which may be used with one embodiment of the present invention. For example, the system 1000 may be implemented including a device that includes the events processing module as shown in FIG. 1. Note that while FIG. 10 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 10, the computer system 1000, which is a form of a data processing system, includes a bus 1003 which is coupled to a microprocessor(s) 1005 and a ROM (Read Only Memory) 1007 and volatile RAM 1009 and a non-volatile memory 1011. The microprocessor 1005 may retrieve the instructions from the memories 1007, 1009, 1011 and execute the instructions to perform operations described above. The bus 1003 interconnects these various components together and also interconnects these components 1005, 1007, 1009, and 1011 to a display controller and display device 1013 and to peripheral devices such as input/output (I/O) devices which may be mice, keyboards, modems, network interfaces, printers and other devices which are well known in the art. Typically, the input/output devices 1015 are coupled to the system through input/output controllers 1013. The volatile RAM (Random Access Memory) 1009 is typically implemented as dynamic RAM (DRAM), which requires power continually in order to refresh or maintain the data in the memory.

The mass storage 1011 is typically a magnetic hard drive or a magnetic optical drive or an optical drive or a DVD RAM or a flash memory or other types of memory systems, which maintain data (e.g. large amounts of data) even after power is removed from the system. Typically, the mass storage 1011 will also be a random access memory although this is not required. While FIG. 10 shows that the mass storage 1011 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1003 may include one or more buses connected to each other through various bridges, controllers and/or adapters as is well known in the art.

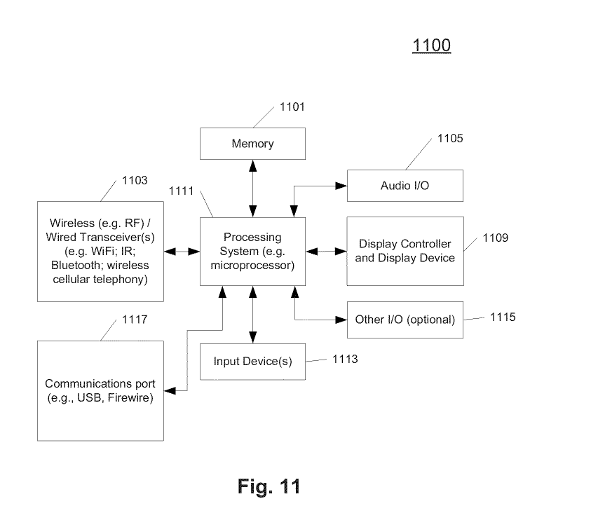

FIG. 11 shows an example of another data processing system 1100 which may be used with one embodiment of the present invention. For example, system 1100 may be implemented as a device 300 as shown in FIGS. 3A-B. The data processing system 1100 shown in FIG. 11 includes a processing system 1111, which may be one or more microprocessors, or which may be a system on a chip integrated circuit, and the system also includes memory 1101 for storing data and programs for execution by the processing system. The system 1100 also includes an audio input/output subsystem 1105, which may include a microphone and a speaker for, for example, playing back music or providing telephone functionality through the speaker and microphone.

A display controller and display device 1109 provide a visual user interface for the user; this digital interface may include a graphical user interface which is similar to that shown on a Macintosh computer when running OS X operating system software, or Apple iPhone when running the iOS operating system, etc. The system 1100 also includes one or more wireless transceivers 1103 to communicate with another data processing system, such as the system 1100 of FIG. 11. A wireless transceiver may be a WLAN transceiver, an infrared transceiver, a Bluetooth transceiver, and/or a wireless cellular telephony transceiver. It will be appreciated that additional components, not shown, may also be part of the system 1100 in certain embodiments, and in certain embodiments fewer components than shown in FIG. 11 may also be used in a data processing system. The system 1100 further includes one or more communications ports 1117 to communicate with another data processing system, such as the system 1500 of FIG. 15. The communications port may be a USB port, Firewire port, Bluetooth interface, etc.

The data processing system 1100 also includes one or more input devices 1113, which are provided to allow a user to provide input to the system. These input devices may be a keypad or a keyboard or a touch panel or a multi touch panel. The data processing system 1100 also includes an optional input/output device 1115 which may be a connector for a dock. It will be appreciated that one or more buses, not shown, may be used to interconnect the various components as is well known in the art. The data processing system shown in FIG. 11 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1100 may be a network computer or an embedded processing device within another device, or other types of data processing systems, which have fewer components or perhaps more components than that shown in FIG. 11.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “classifying,” “processing,” “sending,” “determining,” “performing,” “returning,” “computing,” “coalescing,” “maintaining,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to determine if a received student event indicates that a student is not engaged with mobile social learning system, the method comprising:
receiving the student event, wherein the student event characterizes an engagement the student has with the mobile social learning system;
classifying the student event with a mobile social learning classification, wherein the classifying determines a student event class for the student event;
matching a student event-based trigger with the student event class, wherein the student event-based trigger includes an action to be performed if the student event-based trigger matches the student event; and
if the student event-based trigger matches the student event, performing the action.

2. The non-transitory machine-readable medium of claim 1, wherein the student event is attendance of an online class, participation in a discussion board, and uploading material to the mobile social learning system.

3. The non-transitory machine-readable medium of claim 2, wherein the student event class is selected from the group consisting of an action-based event and a time-oriented event.

4. The non-transitory machine-readable medium of claim 2, wherein the action-based event is selected from the group consisting of a number of user events per time period, a number of posting in a discussion board, and a number of uploads to the mobile social learning system.

5. The non-transitory machine-readable medium of claim 1, wherein the time-oriented events is selected from the group consisting of a time since a last post in a discussion board, a time since last login to the mobile social learning system, and a time since last activity with the mobile social learning system.

6. The non-transitory machine-readable medium of claim 1, further comprising:
coalescing one or more other student events with the received student event.

7. The non-transitory machine-readable medium of claim 1, wherein the student event-based trigger is selected from the group consisting of an action-based trigger and a time-oriented trigger.

8. The non-transitory machine-readable medium of claim 7, wherein the action-based trigger is selected from the group consisting of a trigger based on student attendance, a trigger based on a student assignment, and a trigger based on discussion board participation.

9. The non-transitory machine-readable medium of claim 7, wherein the time-oriented trigger is selected from the group consisting of a trigger based on a time since a last post to a discussion board, and a time since a last activity.

10. A method to determine if a received student event indicates that a student is not engaged with mobile social learning system, the method comprising:
receiving the student event, wherein the student event characterizes an engagement the student has with the mobile social learning system;
classifying the student event with a mobile social learning classification, wherein the classifying determines a student event class for the student event;
matching a student event-based trigger with the student event class, wherein the student event-based trigger includes an action to be performed if the student event-based trigger matches the student event; and
if the student event-based trigger matches the student event, performing the action.

11. The method of claim 10, wherein the student event is attendance of an online class, participation in a discussion board, and uploading material to the mobile social learning system.

12. The method of claim 11, wherein the student event class is selected from the group consisting of an action-based event and a time-oriented event.

13. The method of claim 11, wherein the action-based event is selected from the group consisting of a number of user events per time period, a number of posting in a discussion board, and a number of uploads to the mobile social learning system.

14. The method of claim 10, wherein the time-oriented events is selected from the group consisting of a time since a last post in a discussion board, a time since last login to the mobile social learning system, and a time since last activity with the mobile social learning system.

15. The method of claim 10, further comprising:
coalescing one or more other student events with the received student event.

16. The method of claim 10, wherein the student event-based trigger is selected from the group consisting of an action-based trigger and a time-oriented trigger.

17. The method of claim 16, wherein the action-based trigger is selected from the group consisting of a trigger based on student attendance, a trigger based on a student assignment, and a trigger based on discussion board participation.

18. The method of claim 16, wherein the time-oriented trigger is selected from the group consisting of a trigger based on a time since a last post to a discussion board, and a time since a last activity.

19. A device to determine if a received student event indicates that a student is not engaged with mobile social learning system, the device comprising:
a processor;
a memory coupled to the processor though a bus; and
a process executed from the memory by the processor to cause the processor to receive the student event, wherein the student event characterizes an engagement the student has with the mobile social learning system, classify the student event with a mobile social learning classification, wherein the classifying determines a student event class for the student event, match a student event-based trigger with the student event class, wherein the student event-based trigger includes an action to be performed if the student event-based trigger matches the student event, and if the student event-based trigger matches the student event, perform the action.

20. The device of claim 19, wherein the student event is attendance of an online class, participation in a discussion board, and uploading material to the mobile social learning system.
